(19) United States
(12) Patent Application Publication
(10) Pub. No.: US 2012/0127381 A1
(43) Pub. Date: May 24, 2012

(54) Wide-angle head-up display

(76) Inventors: Matvey Lvovskiy, Brooklyn, NY (US); Alexander Efros, Sanct Petersburg (RU); Ilya Lipkind, Mountain View, CA (US)

(21) Appl. No.: 12/927,723

(22) Filed: Nov. 23, 2010

(51) Int. Cl. G02B 27/01; G02F 1/1335

(52) U.S. Cl. 349/11; 359/633

(57) ABSTRACT

The wide-angle Head-Up display design allows the increase in horizontal peripheral field of view and is based on two, three or more unified informational channels with each of them containing axis-symmetric lens collimating optical system and visualizer comprised of more than one LCD-projectors with each of them containing LCD-matrix and tricolor illuminator, projection lens and integrated for all projectors the transparent-diffusive screen intended for representation of primary images and is located at the object-side focal plane of channel collimating optical system and moreover the primary images are located on the screen so that their adjacent horizontal boundaries are stitched with small overlap in order to ensure the uninterrupted representation of resulting image. The channels' axes are horizontally shifted relative to each other so that adjacent boundaries of peripheral fields of view for the neighboring channels are coincided.

### BACKGROUND OF THE INVENTION

The offered wide-angle Head-Up display (HUD) is intended for generation of predetermined information image and its projection into optical infinity. HUD can be used both for aircrafts and surface and marine transport for control and performance of different tasks.

All known HUDs contain the image generating source and optical collimating system. The projective CRTs of high intensity providing monochromatic (green) ray for image generation are used for most of aircraft HUDs. The HUD by 6,392,812 can be cited as an example of such device application.

The process improvement for diminutive LCD matrixes development makes it possible for them to be competitive devices intended for HUD image generation. The HUDs by U.S. Pat. Nos. 7,482,996 and 7,629,877 represent examples for such possibility to be confirmed.

For Head-Up displays projective CRT or a single LCD-matrix is not a perfect source of image generation. If PCRT is applied high-voltage power supply (15-20 kv) and high capacity D.C. amplifier are necessary for control of the electron ray providing the symbolic information by use of the functional-vector method to gain required image contrast under high ambient light conditions. Accordingly strong power supply and coolers are required. All above-listed requirements and considerable PCRT length cause the HUD overall dimensions and weight increase and high power consumption. In addition limited acceptable beam power density caused by luminophor destruction risk and focusing system resources practically exclude the PCRT resolution and brightness improvements feasibility. The resolution of current PCRT is 10-15 line/mm max for TV-raster Mode.

The considerable decrease of HUD outer dimensions and power consumption is attainable by LCD-matrix application. At the same time HUD based on single LCD-matrix has significant drawback caused by dot structure of image and as a result the disruptions and aliasing can emerge affecting the symbolic information image. When single LCD-matrix is applied for HUD with wide peripheral fields of view the image quality can be even worse than quality of the image generated by similar HUD based on PCRT.

The main features of HUD's optical system are full and instantaneous peripheral fields of view. The maximum size of the information field that an operator is able to see considering supplementary movement of his head is a full peripheral field of view. Instantaneous field of view is that part of full peripheral field of view, that is seen by operator without a head movement. The greater the value of the features, the greater the informational capability that is available which is essential for carrying out certain tasks by use of HUD.

There are two approaches to HUDs collimating optical systems:

axis-symmetric scheme with application of lenses;

two-dimensional symmetric scheme with descent ring of no planar reflecting components including holographic optical elements (HOE).

The feature of axis-symmetric collimating optical system is that in order to increase full peripheral field of view it is necessary to decrease focal length (f) and in order to increase the instantaneous field of view it is necessary to increase clear aperture of output lens (exit pupil D). Thereby in order to increase full and instantaneous fields of view simultaneously the increase of optical system aperture N evaluated by N=D/f is required. However the are always construction based limitations making the unconstrained increase of output lens diameter not possible. For aircrafts it depends on instrument panel layout.

Therefore usually the optical systems are applied in which output lens diameter is 130÷150 mm and full peripheral field of view (circular) is 25° max and instantaneous field of view is approximately 17°×17° and so the considerable horizontal and vertical head movements are required for operator to readout information performed by HUD in its full field of view. Practically the examined configuration of prevalent HUDs based on axis-symmetric collimating optical system is extremely restricted by available technology for full and instantaneous peripheral fields of view to be increased simultaneously.

By application of two-dimensional symmetric scheme for collimating optical system with decent red no planar reflecting components including HOE it is possible to increase both full and instantaneous fields of view significantly (up to 30° horizontally). For such HUD collimating optical system the principal component is the main semitransparent mirror that is 300÷350 wide HOE. It provides the transparency for 85-90% outside luminous flux and reflection of 80% luminous flux from the image generated by PCRT at a narrow spectral range of the luminophor beaming main maximum and consequently the image readability is additionally improved under the high brightness ambient light conditions.

Along with stated advantages the collimating optical system of such type has significant disadvantages and limitations:

manufacturing of a large-dimension HOE for the main mirror is complicated and costly procedure requiring stable laser equipment of high capacity with high seismic stability i.e. protection against any external vibrations;

since the hologram is formed in the thin layer of gelatin superimposed on the substrate made of high quality optical glass with specified form it is necessary for gelatin to meet particularly strict requirements of optical parameters' uniformity. These requirements are extremely difficult for executing under series manufacturing conditions and it is connected with production rise in price;

to preserve hologram under difficult service conditions (high humidity, ambient temperature sharp drops, etc) proper protection is required that is provided by application of the additional faceplate adjoin to the base of the form by use of which the pressurization of gelatin film with the hologram is carried out.

Such operation is difficult and costly also;

the utilization of full visible light spectrum for image generation (except of strictly defined wavelength) is excluded by HOE application for HUD collimating optical system that makes it impossible to represent multicolored information image.

It is exactly by stated reasons that the wide-angle HUDs based on HOE are not widely applicable.

At the same time the urgent problem lies in developing of wide-angle HUD providing both generation of multicolored collimated images and availability of horizontal peripheral fields of view that are equal or exceeded than the HUDs based on HOE peripheral fields of view. The offered and stated below HUD based on new configuration of several axis-symmetric lens systems makes it possible to eliminate considerably the above-listed disadvantages and limitations inherent to existing HUDs based on HOE and to solve the problem defined above.

### SUMMARY OF THE INVENTION

Wide-angle Head-Up display is offered that in order to increase horizontal peripheral field of view is provided with two (or three) unified channels for information representation and each channel is carried out with two-component mirror and axis-symmetric lens collimating optical system and visualizer and at the same time the informational channels' axes are horizontally shifted relative to each other so that the adjacent vertical boundaries of channels' peripheral fields of view is coincided and HUD full peripheral field of view makes the geometric sum of two (three) canals' fields of view.

The offered wide-angle multichannel HUD is carried out with integrated two-component semitransparent mirror for any number of unified informational channels in order to provide the generation of uninterrupted integral collimated image while viewing it against the “outside world” background.

To increase the resolution and brightness for generated image the offered wide-angle multichannel HUD is carried out with visualizers containing more than one identical diminutive LCD projector and each projector is provided with LCD-matrix (its long side is parallel to HUD horizontal axis), illuminator and projecting objective and integrated for all projectors the transparent-diffusive screen that is intended for primary images representation and positioned at object-side focal plane of the channel collimating optical system. At the same time primary images are located on the screen so that their adjacent horizontal boundaries is stitched with small overlap of several pixels.

To provide the generation of multicolored image for offered HUD the LCD-projectors are carried out with tricolor illuminators.

### BRIEF DESCRIPTION OF THE DRAWINGS

Detailed description of the present invention is followed by reference to the accompanying drawings in which similar elements are indicated by similar references and numerals.

FIG. 1A shows block-diagram of unified information channel that is basic for architecture of offered multichannel wide-angle HUD.

FIG. 1B shows block-diagram of visualizer containing LCD-projectors that is applied for offered multichannel wide-angle HUD.

FIG. 2 shows two-channel HUD with integrated two-component mirror (HUD vertical view).

FIG. 3 shows full and instantaneous fields of view diagrams for two-channel HUD (instantaneous field of view is indicated by hatching).

FIG. 4 shows three-channel HUD with two-component integrated mirror (HUD vertical view).

FIG. 5 Shows diagrams of full and instantaneous fields of view for three-channel HUD (instantaneous field of view is indicated by hatching).

### DETAILED DESCRIPTION OF PREFERRED EMBODIMENT OF THE INVENTION

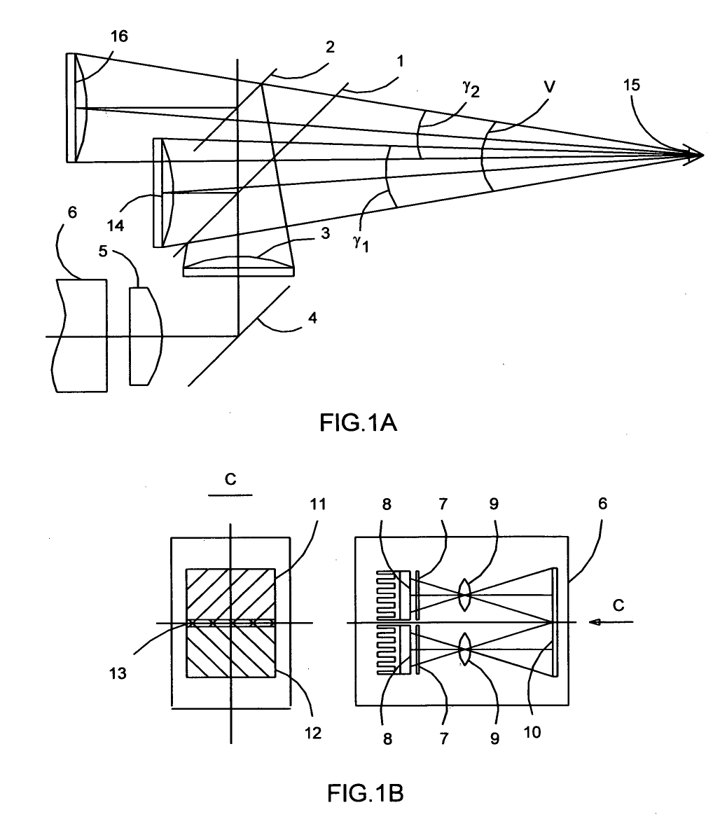

The offered wide-angle HUD is based on two or three unified informational channels. FIG. 1A shows the block-diagram of single unified informational channel containing two-component mirror that is carried out by use of two semitransparent mirrors 1 and 2 that are parallel moved apart and lens collimating optical system consisting of output lens component 3, fully reflective mirror 4 intended for optical axis to be re-routed and input lens component 5 and also the visualizer 6 providing the generation of primary luminous image at the objective-side focal plane of the channel collimating optical system. In order to increase the resolution and brightness of generated image the channel is provided with visualizers containing more than one identical LCD-projector, for example two.

For example FIG. 1B shows the block-diagram of visualizer 6 consisting of two identical diminutive LCD-projectors each containing LCD-matrix 7 (with its long side being located parallel to HUD horizontal axis and so the matrix capabilities could be used more effectively) with tricolor illuminator 8, projection lens 9, and integrated for both projectors the transparent-diffusive screen 10 provided for representation of primary images and positioned at object-side focal plane of channel collimating optical system. At the same time primary images 11 and 12 from the corresponding projectors are located at the screen so that their adjacent horizontal boundaries are stitched with small overlap 13 of several pixels.

In this case each projector of visualizer is representing on the screen half of the image generated by unified informational channel.
The availability of more than single LCD-projector for visualizer makes it possible due to use of maximum luminous flux and corresponding increase of resolution to attain the high quality image generated by informational channel that is exceeded for resolution and brightness than the image generated by known HUDs based on PCRT. The application of lens collimating systems and LCD-projectors with tricolor illuminators for the offered HUD enables it to generate the multicolored collimated image thus providing the increased information resources for it.

Depicted on FIG. 1A two-component mirror 1, 2 is operating as following:

lower component is representing the mirror view 14 of the lens component 3 and providing the instantaneous peripheral field of view with vertical size γ₁ for operator 15;

upper component 2 is representing the mirror view 16 of the lens component 3 and providing the instantaneous peripheral field of view with vertical size γ₂ for operator 15.

To exclude the loss of information in central zone the lower (γ₁) and upper (γ₂) fields are overlapped and usually the relation γ₁+γ₂=(1.5÷1.6) γ₁ is obtained.
Therefore due to the two-component mirror application the instantaneous field of view V (vertical) of each informational channel and of the whole HUD is increased by 1.5÷1.6 in comparison with the single-component mirror.

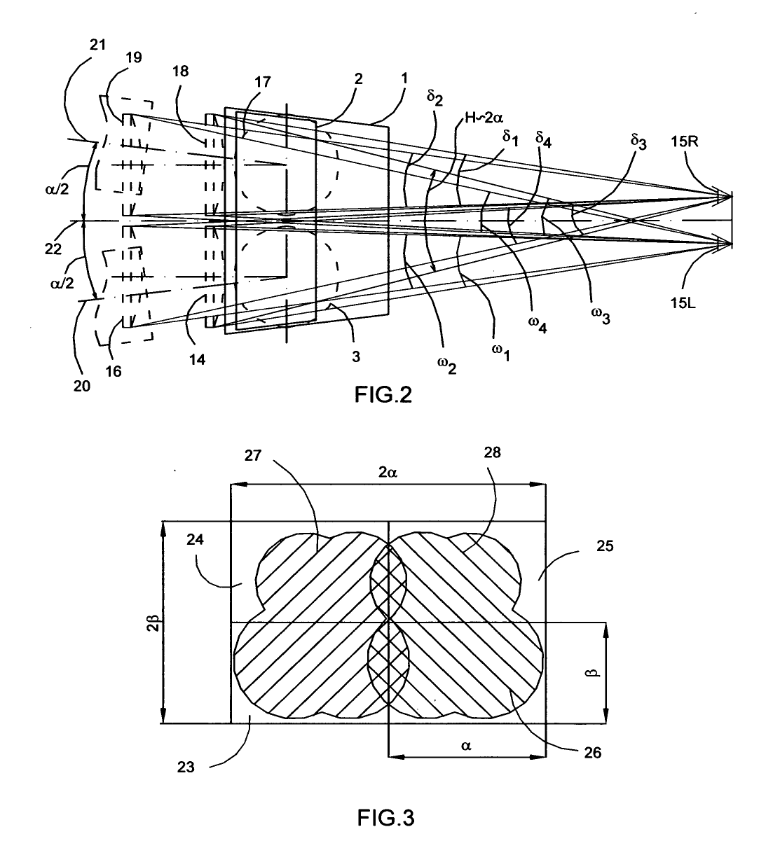

FIG. 2 shows the two-component HUD vertical view indicating the integrated for both channels two-component mirror 1 and 2, output component 3 of the left informational channel and its mirror views 14, 16 (depicted by FIG. 1A) and also the output component 17 of the right informational channel and its mirror views 18, 19. The axes of left 20 and right 21 informational channels are shifted in horizontal plane relatively to HUD vertical symmetry plane 22 by the angle α/2 where α—the horizontal size of full peripheral field of view for the unified informational channel. At the same time the adjacent vertical boundaries of peripheral fields of view for two channels are overlapped and the HUD full peripheral field of view is a total of two channels peripheral fields of view as it is indicated at FIG. 3.

The total instantaneous field of view for two-component HUD is made up of eight cones of rays:

four cones δ₁, δ₂, δ₃, δ₄ based on images 18, 19, 14 and 16 respectively with the vertex located at operator's right eye 15R;

four cones ω₁, ω₂, ω₃, ω₄ based on images 14, 16, 18 and 19 respectively with the vertex located at operator's left eye 15L.

The horizontal size H of total instantaneous peripheral field of view for two-channel HUD is approximately equal to 2α size of the full peripheral field of view for the same HUD and the shape of total instantaneous peripheral field of view is corresponding to the diagram shown at FIG. 3.
The horizontal overall dimensions of two-component mirror is sufficient for the images generated by both channels to be seen in the form of uninterrupted wide-angle collimated image of information against an “outer world” background.

The diagram depicting fields of view for the offered HUD is shown at FIG. 3. All linear dimensions at the diagram is carried out proportionally to corresponding angular dimensions of fields of view. The diagram indicates:

peripheral field of view (α×β) formed by each of LCD-projectors (23, 24, 25, 26);

full peripheral field of view (α×2β) of each of the informational channels (23+24, 25+26);

total full peripheral field of view (2α×2β) of the two-channel HUD (23+24+25+26).

The diagram depicts also the instantaneous fields of view for left channel 27 and right channel 28 that are overlapped at the field of view central zone and amount to 85-90% of the two-channel HUD full peripheral field of view.

Since full peripheral field of view of wide-angle HUDs based on HOE is approximately 30°×20° it is worth to consider the attainability of the similar parameter for offered two-channel HUD by use of following example. On condition that α×β is equal to 15°×10° that is feasible value the full peripheral field of view for the offered display is 2α×2β=30°×20° (see FIG. 3) that is corresponding to the HUD based on HOE.

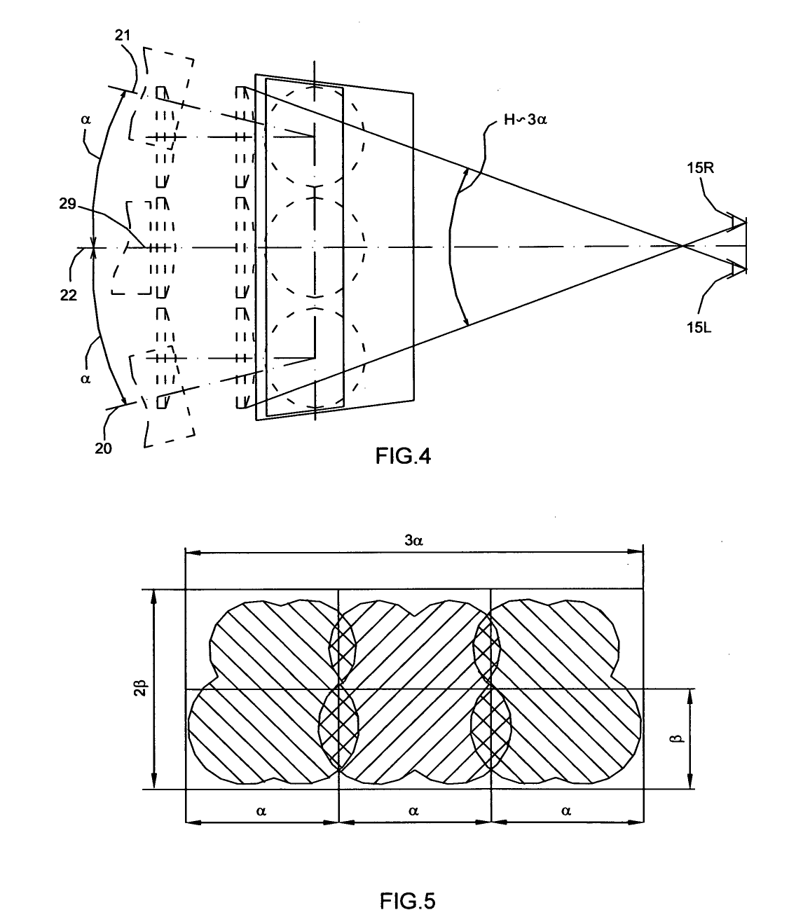

The feasibility for horizontal widening of field of view for the offered HUD is confirmed by FIG. 4 depicting the scheme of display with three informational channels (vertical view). The optical system axis 29 of the third channel is located at vertical symmetry plane 22 of three-channel HUD and the optical systems' axes of the left 20 and right 21 channels are shifted relative to the plane 22 by the angle that is equal to the angular horizontal size of full peripheral field of view of the single informational channel. By application of calculation procedure similar to that for the two-channel HUD it is possible to prove that horizontal size H of total instantaneous peripheral field of view of three-channel HUD is approximately equal to the size 3α of full peripheral field of view for the same HUD and the shape of total instantaneous field of view is corresponding to the diagram demonstrated at FIG. 5.

Similarly to the two-channel HUD and with α×β=15°×10° as an example the total dimensions of full peripheral field of view for three-channel HUD is 3α×2β=45°×20° that is illustrated at FIG. 5. It should be noted that the number of channels is restricted only by the mirror outer dimensions and space that is available for HUD positioning. In fact the panoramic attribute is gained by the offered display and ample opportunities are provided for its multipurpose application.

While considering the feasibility of offered multichannel wide-angle HUDs it should be noted that currently there is no obstacles relating to technology, materials or manufacture for their industrial production. In this case the feasibility for HUD optical components to be carried out of acrylic optics is attractive and makes it possible to decrease HUD weight considerably and reduce cost of series manufacture.

### ADVANTAGES OF THE INVENTION

The wide-angle Head-Up display that in order to increase its horizontal full peripheral field of view is carried out with two or three unified informational channels located in horizontal plane and the image generated by each of them is equal to half or one third fraction of the total image. At the same time collimating optical systems of the channels are based on lens optics and conjugated with integrated two-component semitransparent mirror intended for uninterrupted viewing of total collimated image generated by the display against the “outer world” background.

For offered two-channel Head-Up display full and instantaneous fields of view are considerably exceeded than similar angular parameters of all known Head-Up displays based on lens optics that are intended for various types of application and described by patent information.

The horizontal dimensions of full and instantaneous peripheral fields of view that is obtained for two-channel Head-Up display are approximate to similar parameters of Head-Up displays based on HOE and for the three-channel Head-Up display the mentioned parameters are increased by 1.5.

The availability of two or three informational channels for offered Head-Up display and each of them containing the visualizer with more than single LCD-projector makes it possible to achieve high quality generation of total image with its parameters (resolution and brightness) considerably exceeding the same parameters of the image generated by Head-Up displays based on CRT.

As opposed to the Head-Up displays based on HOE that is capable of only monochrome image generation caused by physical peculiarities of HOE operation and also the majority of aircraft Head-Up displays utilizing the projective monochrome CRT to provide the required image brightness the Wide-angle Head-Up display under consideration is capable to provide the generation of both monochrome and multicolored images of high resolution and their observability, against the illuminated “outer world” background owing to the structure that is offered. This is specified by following:

lens collimating system of display is operating at full visible-light spectrum,

application of LCD-projectors with tricolor illuminator for visualizer makes it possible for Head-Up display to generate multicolored collimated image;

luminous flux from each LCD-projector is concentrated only at one-fourth (or one-sixth) fraction of the Head-Up display full peripheral field of view that makes it possible to increase resolution and brightness of collimated image generated by Head-Up display for any color (red, blue, green, etc.);

optimization of brightness levels for various colors by use of LCD-projectors makes it possible to provide the required contrast for all fragments of collimated image against high illuminated “outer world” background.

Only lens components and flat mirrors are utilized for collimating optical systems for the offered Head-Up display and therefore there is feasibility condition for the application of optical acrylic components manufacturing procedure (foundry, pressure forming, etc) that makes it possible to decrease the Head-Up display weight considerably and reduce the price. Currently there is practically no obstacles relating to technology, manufacture or materials for development and large-scale production feasibility of the offered multichannel Head-Up display based on novel conceptual approach for the goal attainment.

What is claimed:

1. Wide-angle Head-Up display containing two-component mirror composed of two semitransparent mirrors that are moved apart and mutually parallel and informational channel containing axis-symmetric lens collimating optical system and visualizer generating primary image at object-side focal plane of optical system whereas in order to increase horizontal full and instantaneous fields of view display is supplemented by single or two similar informational channels with their axes shifted horizontally so that adjacent vertical boundaries of neighboring channels' peripheral fields of view are overlapped and a Head-Up display's full peripheral field of view is equal to a sum of two or three channels' peripheral fields of view respectively.

2. Wide-angle Head-Up display by Cl. 1, whereas in order to ensure stitching of vertical boundaries of informational channels' peripheral fields of view (for display with two similar channels) axis of left and right channels are horizontally shifted to the left and to the right relative to Head-Up display vertical symmetry plane by an angle that is equal to the half of full peripheral field of view horizontal size for a single informational channel.

3. Wide-angle Head-Up display by Cl. 1, whereas in order to ensure stitching of vertical boundaries of informational channels' peripheral fields of view (for display with three similar channels) axis of the middle channel is coincident with display vertical symmetry plane and axes of left and right channels respectively are shifted horizontally to the left and to the right relative to display's vertical symmetry plane by the angle that is equal to horizontal size of full peripheral field of view for single informational channel.

4. Wide-angle Head-Up display by Cl. 1, whereas in order to increase resolution and brightness of generated image it is carried out with visualizers containing two or more similar LCD-projectors and each of them is provided with LCD-matrix (with its long side located parallel to display horizontal axis) and illuminator, projective objective and installed at object-side focal plane of a channel collimating optical system, transparent-diffusive screen that is integrated for all projectors and intended for primary images representation and at the same time:
ratio of the area of primary images generated by each LCD-projector and the area of the resulting image on the screen is inversely proportional to the number of LCD-projectors that are used for visualizer;
primary images are located at the screen so that their adjacent horizontal boundaries are stitched with small overlap (several pixels).

5. Wide-angle Head-Up display by Cl. 4, whereas in order to provide the generation of multicolored image it is carried out with LCD-projectors containing tricolor illuminators.
